(19) United States
(12) Patent Application Publication
(10) Pub. No.: US 2002/0083020 A1
(43) Pub. Date: Jun. 27, 2002

(54) Method and apparatus for providing postage over a data communication network

(75) Inventor: JP Leon, San Carlos, CA (US)

Correspondence Address: Townsend and Townsend and Crew LLP, Two Embarcadero Center, 8th Floor, San Francisco, CA, 94111, US

(73) Assignee: Neopost Inc., Hayward, CA

(21) Appl. No.: 09/999,409

(22) Filed: Oct. 31, 2001

Related U.S. Application Data
(63) Continuation-in-part of application No. 09/708,913, filed on Nov. 7, 2000.

(51) Int. Cl. G06F 17/00

(52) U.S. Cl. 705/401

(57) ABSTRACT

A method for dispensing postage includes receiving, at a postal vendor system, a proxy request from a proxy server system. The proxy server system generates the proxy request in response to a postage purchase request including one or more criteria about desired postage from a user. First postage information for printing a postage indicium is transmitted from the postal vendor system to the proxy server system. The proxy system is not authorized to dispense postage by a postal authority, but the postal vendor system is authorized to dispense postage by the postal authority.

### CROSS-REFERENCE TO RELATED APPLICATIONS

The present applications is a continuation-in-part of U.S. patent application Ser. No. 09/708,913, filed on Nov. 7, 2000, which is herein incorporated by reference for all purposes.

### COPYRIGHT NOTICE

A portion of the disclosure of this patent document contains material which is subject to copyright protection. The copyright owner has no objection to the xerographic reproduction by anyone of the patent document or the patent disclosure in exactly the form it appears in the U.S. Patent and Trademark Office patent file or records, but otherwise reserves all copyright rights whatsoever.

### BACKGROUND OF THE INVENTION

The present invention generally relates to dispensing postage, and in particular to computer-based dispensing of postage over a data communication network.

Millions of small businesses employ a variety of tools in their daily operations, such as telephones, copying machines, telefax machines, and personal computers (PC's). Of note is the rapid acceptance of PC's in the small business environment. In the past, computers were available only to large companies which could afford the bulky and quite expensive machines. The development and continuing evolution of semiconductor technology has changed the computer usage model, and has made powerful computing capability available to the general public.

A key component of a business is the mailing and receiving of correspondence, between businesses and with its customers. Consequently, the mechanical postage meter has become a ubiquitous item in most business operations. However, unlike the proliferation of PC's, conventional postage meters have not achieved the market penetration that other conventional pieces of office equipment have. The primary reason is a perceived high (and recurring) cost of postage meters, which outweighs their convenience in the eyes of potential users.

At the other end of a business operation is the consumer. In the case of the Internet, consumers who purchase goods over the Internet are sometimes faced with the inconvenience of having to return the product. One aspect of that inconvenience is that the consumer does not have access to high denomination stamps that goods may require, or the weighing scale needed to weigh the goods. Consequently, a lengthy and usually tedious trip to the post office is required. This experience is totally at odds with the ease and speed associated with an Internet purchase.

The United States Postal Service (USPS) has promulgated specifications for its Information Based Indicia Program (IBIP). The IBIP program supports new methods of applying postage in lieu of conventional approaches that typically rely on the use of a postage meter mechanically printing the indicium on mailpieces.

The IBIP program contemplates postal indicia printed by conventional printers (e.g., thermal, inkjet, or laser) and including human-readable and machine-readable portions. An indicium refers to the imprinted designation or a postage mark used on mailpieces denoting evidence of postage payment. The machine-readable portion was initially specified to be a two-dimensional barcode symbology known as PDF417. The indicium content includes a digital signature for security reasons (to preclude forgery). There are separate specifications for open and closed systems.

The specifications have been updated over the last few years; the recent specifications for open and closes systems are:

Information-Based Indicia Program (IBIP) Performance Criteria for Information-Based Indicia and Security Architecture for Open IBI Postage Evidencing Systems (PCIBI-O) (Draft Feb. 23, 2000), and

Information-Based Indicia Program (IBIP) Performance Criteria for Information-Based Indicia and Security Architecture for Closed IBI Postage Metering Systems (PCIBI-C) (Draft Jan. 12, 1999).

These specifications are incorporated by reference in their entirety for all purposes.

An open system is defined as a general purpose computer used for printing information-based indicia, but not dedicated to the printing of those indicia. A closed system is defined as a system whose basic components are dedicated to the production of information-based indicia and related functions, that is, a device dedicated to creating indicia similar to an existing, traditional postage meter. A closed system may be a proprietary device used alone or in conjunction with other closely related, specialized equipment, and includes the indicium print mechanism.

The IBIP program specifies a postal security device (PSD) that manages the secure postage registers and performs the cryptographic operations of creating and verifying digital signatures.

The open system specification describes a host system (a computer or postage meter) connected to an unsecured printer (e.g., a laser printer or the like) and a PSD. The host system also provides communication facilities that allow the PSD's vendor and/or the USPS to establish communications with the PSD. Communications supported include troubleshooting, accounting transactions, and the like.

The PSD and host cooperate to provide an indicium, which is then transmitted to and printed by the unsecured printer. The specified indicium allows the use of an unsecured printer (e.g., thermal, inkjet, or laser) by using a digital signature, which also supports authentication of the mail piece. The indicium includes human-readable information and machine-readable information (initially specified as a PDF417 two-dimensional bar code). Each PSD is a unique security device, having core security functions such as digital signature generation and verification and secure management of information (e.g., descending and ascending registers).

U.S. Pat. No. 6,005,945 to Whitehouse discloses a system for electronic distribution of postage using a secure central computer which generates postal indicia in response to postage requests submitted by end user computers. However, these conventional techniques, including the system described in the Whitehouse patent, still require the user to apply for and obtain a license. As a result, a user still has to suffer the inconveniences and bureaucratic hurdles of obtaining the license. Thus, even though the conventional electronic postage distribution techniques have reduced the inconveniences associated with traditional postage meters, they are still significantly unwieldy.

A need therefore exists to simplify the attainment of postage using a computer. It is further desirable to provide a computer-based approach that facilitates access to postage by the consuming public.

### SUMMARY OF THE INVENTION

In one embodiment of the present invention, a method for dispensing postage includes receiving, at a postal vendor system, a proxy request from a proxy server system. The proxy server system generates the proxy request in response to a postage purchase request including one or more criteria about desired postage from a user. First postage information for printing a postage indicium is transmitted from the postal vendor system to the proxy server system. The proxy system is not authorized to dispense postage by a postal authority, but the postal vendor system is authorized to dispense postage by the postal authority.

The method includes receiving information about a product purchased from a retailer affiliated with the proxy system from the user. The product is identified using the information about the product purchased. Cost of shipping the product from a user location to a retailer location is determined. The proxy request incorporates information representing the determined shipping cost. The postage indicium is printed using the second postage information. The product is shipped with the printed postage indicium affixed thereto from the user location to the retailer location.

The retailer or its affiliate has an account established with the postal authority to settle any postage deficiency in connection with shipping the product to the retailer location or receive credit for any postage overcharge in connection with shipping the product to the retailer location.

The postage deficiency is the difference between an actual postage cost of shipping the product and a value of the printed postage indicium if the difference is a positive value, and the postage overcharge is the difference between an actual postage cost of shipping the product and a value of the printed postage indicium if the difference is a negative value. The retailer or its affiliate bills or credits the user for the deficiency or overcharge. The postal authority is a governmental agency, quasi-governmental agency, or private entity.

In another embodiment, a communication system for dispensing postage includes a communication network. A proxy server system is coupled to the communication network and configured to receive a postal purchase request that includes one or more criteria about desired postage from a user. The proxy system generates a proxy request in response to the postal purchase request. The proxy system is not authorized to dispense postage by a postal authority. A postal vendor system is coupled to the communication network and configured to receive the proxy request from the proxy server system and generate first postal information for printing a postage indicium in response to the proxy request. The postal vendor system is authorized to dispense postage by the postal authority.

In yet another embodiment, a method for dispensing postage includes receiving, at a postal vendor system, a proxy request from a postal authority system. The postal authority system generates the proxy request in response to a postage purchase request transmitted by a user to the postal authority system. The proxy request includes one or more criteria about postage desired by the user. First postage information for printing a postage indicium that satisfies the one or more criteria is transmitted from the postal vendor system to the postal authority system.

### BRIEF DESCRIPTION OF THE DRAWINGS

FIG. 1A illustrates a typical system arrangement for dispensing postage according to one embodiment of the present invention.

FIG. 1B illustrates a typical system arrangement for dispensing postage according to another embodiment of the present invention.

FIG. 2 shows the data transfers that take place during the dispensing of postage according to one embodiment of the invention shown in FIGS. 1A and 1B.

FIG. 3 shows the processing that takes place during the dispensing of postage according to one embodiment of the invention shown in FIGS. 1A and 1B.

FIG. 4 depicts an exemplary individual pre-printed label on which an indicium may be printed according to an embodiment of the present invention;

FIG. 5 depicts a sheet of pre-printed labels according to one embodiment of the present invention;

FIG. 6 depicts an individual label with an indicium printed on it according to one embodiment of the present invention;

FIG. 7 is an expanded block diagram of a postage vendor system according to one embodiment of the present invention.

FIG. 8 is a simplified flowchart showing processing performed by the various components of a postage vendor system upon receiving a request to purchase postage according to one embodiment of the present invention.

### DESCRIPTION OF THE SPECIFIC EMBODIMENTS

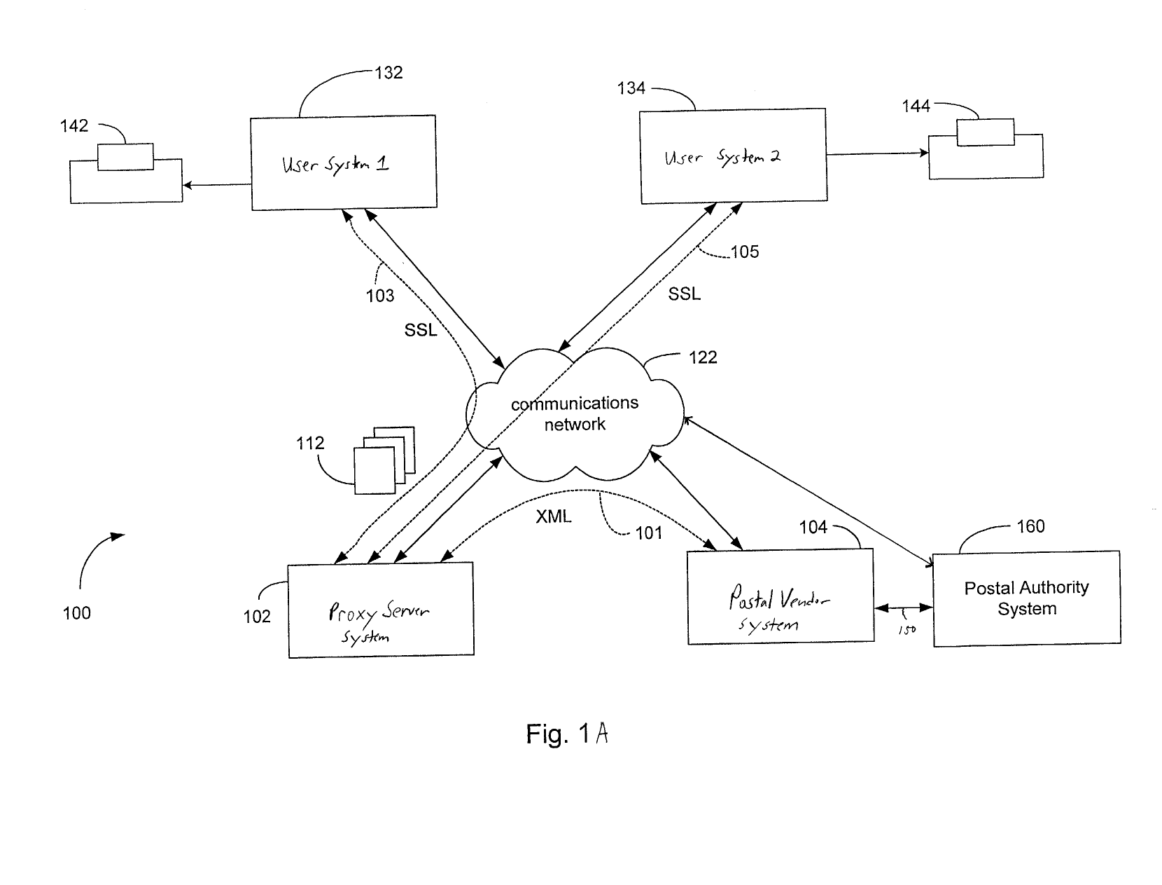

The present invention provides techniques for dispensing value indicia, e.g., postage, using a communication network. FIG. 1A shows an exemplary data communication system 100 according to one embodiment of the invention. The data communication system comprises a proxy server system or first data server 102, a postal vendor system or second data server 104, and a postal authority system 160. These systems are in data communication over a communications network 122. The postal authority system and the postal vendor system may additionally communicate with each other using a dedicated communication channel 150 to more securely exchange sensitive data. One or more user systems 132 and 134 access proxy server system 102 via the communication network.

As shown in FIG. 1A, communication system 100 provides the users or user systems 132 and 134 with the convenience of purchasing postage either directly from the postal vendor system or indirectly via the proxy server system. However, the embodiments described herein will focus on the techniques of purchasing postage indirectly from the postal vendor system via the proxy server system since the direct postage purchase techniques are described in other patent applications that are assigned to the present assignee. For example, the techniques of purchasing postage directly from the postal vendor system are described in U.S. patent application Ser. No. 09/708,883, filed on Nov. 7, 2000, which is incorporated herein by reference for all purposes. A person skilled in the art can easily apply the teachings of U.S. patent application Ser. No. 09/708,883 to the present invention.

In one embodiment, proxy server system 102 is a web server operated by a third party, providing HTML-based content 112 to users 132, 134. The web server can be any data processing machine or machines running (executing) appropriate system and applications software such as the operating system (OS). Server software running on the proxy server system provides the web content comprising the web pages which constitute a web site. Thus, for example, Yahoo® is a web site comprising numerous web pages that can be accessed by a user. Large web sites typically have multiple server machines to provide adequate system throughput. Thus, each of the systems 102 and 104, shown in FIG. 1A, may be one or more physical machines, though logically each is viewed as a single server machine (system).

According to the embodiments of the present invention described herein, use of proxy server system 102 enables the operator of postal vendor system 104 to increase its market reach since the users are allowed to purchase postage not only from the postal vendor system but also from proxy system 102 which may be a third party web site, such as Yahoo!, AOL, Amazon.com, Shoebuy.com, etc. In one embodiment, the postal vendor system may be coupled to a plurality of proxy server systems or to a single proxy system. In another embodiment, where there are a plurality of proxy server systems 102, one of them may be a web server of postal authority system 160. Yet in another embodiment, the proxy server system of a communication system 100′ is a postal authority system 102′, so that postal authority system 102′ serves both as a proxy server system and a postal authority system (FIG. 1B). However, for illustrative convenience, the embodiments of the present invention are described herein by making references primarily to communication system 100 of FIG. 1A.

Referring back to FIG. 1A, postal vendor system (PVS) 104 is a system authorized by a postal authority, e.g., the U.S. Postal Service, to dispense postage. As will be explained in more detail below, in one embodiment, the postal authority is an organization created by the United States government, which can authorize PVS 104 to dispense postage in the same way that today's postage meters are “authorized” to dispense postage.

Accordingly, PVS 104 is primarily responsible for dispensing postage in response to postage purchase requests received from user systems 132 and 134 via the proxy system 102. PVS 104 may itself be comprised of multiple interconnected computer and server systems and communication links. PVS 104 may be configured to receive postage requests from proxy system 104 (or user systems 132 and 134 in other embodiments), validate the postage requests, generate information for printing indicia in response to the postage requests, perform security functions related to the postage transactions, manage funds related to the postage transactions, communicate the information for printing the indicia to the proxy system, and other functions. These functions are generally performed by software code modules executed by PVS 104. Alternatively, these functions may be also performed by hardware modules of PVS 104, or a combination thereof.

In one embodiment, a single postal license number is assigned to each PVS 104 by a postal authority such as the USPS. PVS 104 uses the single postal license number to cater to postage requests from a single proxy server system 102 or from a plurality of proxy server systems 102 that may be operated by different entities. Thus, according to the present invention, a single postal license number is effectively shared between one or more entities. This is substantially different from conventional postage vending techniques wherein a user is required to apply for and receive at least one unique postal license number. Accordingly, the present invention provides a level of postage buying convenience heretofore not achieved by conventional techniques. Since the postal license number is associated with PVS 104 rather than with the proxy server or users accessing the proxy server, the users and proxy system operators are shielded from the procedural steps required for obtaining the postal license number. In fact, according to the present invention, the consumer of the postage does not even have to be aware of the postal license number. A user may buy postage by simply sending a postage request to proxy system 102 and receiving information for printing one or more indicia corresponding to the request from proxy system 102.

Postal authority system (PAS) 160 may comprise one or more computer systems managed by a postal authority authorized to regulate and control postal matters. Examples of postal authorities include the United States Postal Service (USPS), France's La Poste, UK's Royal Mail, and others. In most instances, the postal authority is a governmental or quasi-governmental agency authorized to oversee postal matters. PAS 160 may be coupled to PVS 104 via communication network 122 or directly via some other communication link 150. The information exchanged between PVS 104 and PAS 160 may include finance information, information required by the postal authority for audit purposes, status information, security information, and other like information. The information required by the postal authority for audit purposes may include information identifying the postage buyers, the postage value and amount purchased by the buyers, and other information. PVS 104 may be configured to download information to PAS 160 on a periodic basis using batch processing, or upon the occurrence of certain events. PVS 104 may also be configured to purchase postage from PAS 160.

Each user system or user (client) 132 or 134 typically comprises a conventional personal computing machine (PC) running conventional user software (not shown) and includes a printer 142 or 144. Typical PC's include Macintosh® PC's from Apple Computer, Inc., Intel®-compatible PC's, and so on. Data servers or systems 102 and 104 are typically high-end computing machines capable of high speed operation and much higher data storage capacity than typical PC's. Computing systems suitable for user machines and server systems are well known and do not require additional discussion to one of ordinary skill in the art.

Similarly, server software and user software systems are known. In the following discussion, the illustrative embodiment of the present invention uses the World Wide Web, and so the user software is a component referred to as a “web browser.” For example, Netscape Navigator® by Netscape Communication Corporation is a popular web browser. Another browser is Internet Explorer® by Microsoft Corporation.

Data communication is typically achieved by a modem connection over a conventional telephone line, or telephone lines upgraded for DSL service. Other hardware that can be used include ethernet cards (so-called network interface cards, NIC) which allow connection to an ethernet backbone. Alternative high-speed communication media are becoming available, including cable modem and wireless services, which provide internet access over radio frequency communication channels. These and other communication media are known to those of ordinary skill in the art.

Flows 103 and 105 are date flows between each respective users 132 and 134 and proxy system 102. These data flows are generally secured. In the context of Internet protocols, secured data communication between a web site and a browser is achieved by the secured sockets layer (SSL) protocol. This is a protocol designed by Netscape Communications Corporation to provide encrypted communications for secured transactions on the Internet. SSL is layered beneath application protocols such as HTTP, SMTP, Telnet, FTP, Gopher, and NNTP and is layered above the connection protocol TCP/IP.

Communications network 122 can be a public switched telephone network (PSTN), a cable modem connection, a locally provided private network (e.g., an intralan), or any of a number of known variations of the foregoing. The communications network may itself comprise many interconnected computer systems and communication links. The communication links may be hardwire links, optical links, satellite or other wireless communications links, wave propagation links, or any other mechanisms for communication of information. While in one embodiment the communications network is the Internet, in other embodiments, the communications network may be any suitable computer network. For example, proxy system 102 can be accessed over the Internet by users 132 and 134 or from within the confines of a business that has a privately maintained network and a gateway to the Internet.

A secure data communication channel 101 also exists between proxy system 102 and PVS 104. As will become clear below, a secure link is used to prevent tapping of the channel and fraudulently obtaining information from PVS 104 in one embodiment of the present invention. Communication channel 101 is typically an XML-based (Extensible Markup Language) channel. However, systems 102 and 104 may be linked by alternative secured means, e.g., a dedicated land line or a virtual private network.

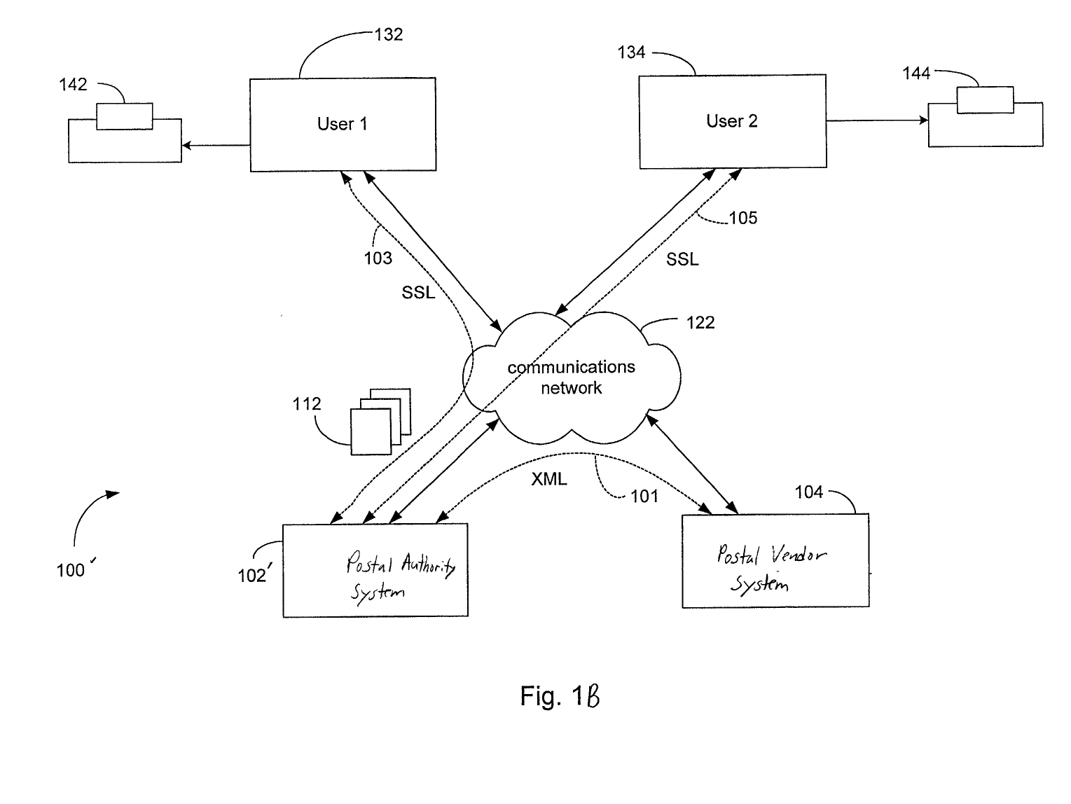

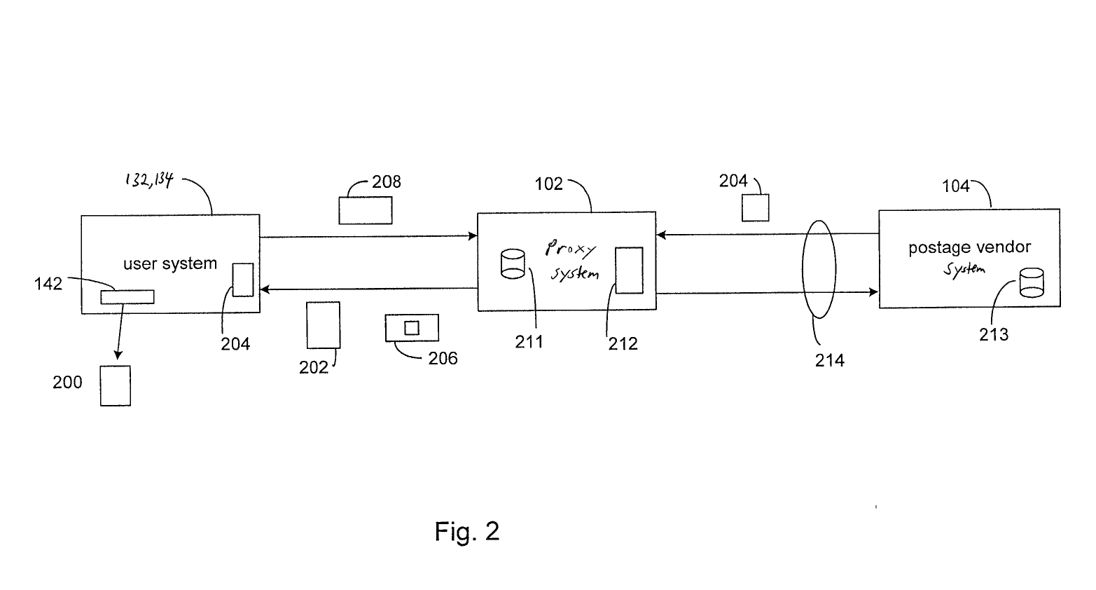

Referring to FIGS. 2 and 3, server software 212 running on proxy system 102, in accordance with the invention, includes functionality to provide a portal through which postage can be distributed from postage vendor system 104 to users visiting the web site being maintained at the proxy system. For the discussion of the illustrative embodiment which follows, user 132 comprises a Windows®—based OS (e.g., Windows 95) provided by Microsoft Corporation, though it is understood that other OS technologies can be used.

A user gains access to a web site maintained by proxy system 102 (step 302). A “web site” is any computer on the Internet running a World-Wide Web server process. A particular web site is identified by the hostname part of a URL (universal resource locator), which maps to an Internet address. Since proxy system 102 is simply a computer running many programs, it may host more than one web site. Each “web site” typically has its own World-Wide Web server process 212 and a hostname uniquely associated with the server process. Consequently, the term “web site,” “web server,” and server process 212 will be used interchangeably in the following discussion. Although proxy system 102 may comprise more than one “web site,” each having its associated server process 212, for the sake of simplicity, the discussion will assume that a single web site is instantiated at the proxy system.

The server process 212, which effectuates the presence of the “web site,” provides interaction with the user by way of a series of web pages. One of the web pages contains information relating to the purchase of postage. For example, the web site might offer a “communication page” which provides its visitors with a choice of a variety of forms of communication. This might include facsimile transmission capability of locally stored electronic documents, electronic mail (e-mail), conventional postal mail, and so on. In this model, the “communication page” serves to draw users to the site. This increases the potential for “hits” at this web site, which in turn becomes an incentive for advertisers to post their ads in this site's web pages.

The “communication page” includes computer graphics representing hypertext links which, when “clicked,” will take the user through a series of web pages that will ultimately allow him or her to select postage. A first of the series of web pages will typically be a logon screen, where the user is asked to sign onto a user account in order to request postage.

At step 304, the user selects the desired postage. This step may be as simple as providing a page having a list of graphics (e.g., radio buttons) which identify the postage that can be obtained by the user. Alternatively, it may comprise a series of additional web pages for accessing postage, including web pages to assist in computing the correct postage for a given package and destination, reconciling account balances, and so on. The complexity level will depend on the features that are desired for visitors of the web site, and is not germane to the present invention.

Embodiments of the present invention may be used by an Internet retailer to enable its customers to obtain postage label for the returned item(s). Since the retailer knows the approximate shipping weight of the item, it can estimate or determine the required postage. In this case, selection of postage (step 304) simply involves the customer entering some information identifying the goods to be returned, which the retailer can associate with a postage amount. Depending on the retailer's policy, the return postage amount may or may not be billed to the customers. In one embodiment, the retailer may set up an account with the postal authority, e.g., the USPS, so that the postal authority may debit or credit the account on any difference between the estimated postage amount and the actual postage amount. The retailer may then bill or credit the difference to the customers if the retailer's policy is to bill the return postage amount to the customers. Alternatively, where the estimated amount is less than the actual amount, i.e., where there is a postage deficiency, the retailer may simply pick up the difference as a goodwill gesture if the difference is no more than a given amount. In this Internet retailer model, the postal authority may be a non-governmental agency, such as, United Parcel Service Inc. or Federal Express Corporation.

At step 306, the request is validated to ensure that sufficient funds exists for payment of the requested postage before the request is processed. In one embodiment, the proxy system or web site server 102 maintains user account information in its database 211 for its users. The user account information can be consulted to determine whether or not to process the request. In the Internet retailer model, the web site account information might comprise information about the goods the customer wishes to return. A return authorization code may be provided with the goods when they are shipped to the customer (or obtained subsequently via telephone or the Internet) and may serve as a validation code.

In another embodiment of the invention, proxy system 102 can provide off-the-street type purchasing of postage, where individual user accounts do not have to be maintained by the web site. The user would simply provide some sort of valid payment mechanism (e.g., credit card information), after which the web site would continue processing the postage request. This embodiment of the invention has the advantage of simplifying the administration tasks of the proxy system. It might be appealing to users who want to make an occasional purchase of postage without having to open an account with the proxy system.

Continuing, server process 212 then sends (step 308) the user's postage request to postage vendor system or server 104, preferably over a secured communication link. As noted above SSL is a commonly used protocol for secured transactions between a server (e.g., web site) and a user (e.g., web browser). A commonly used protocol for secured communication between server sites is XML. In practice, proxy system or web site 102 is likely to receive requests for postage from many users accessing the web site server concurrently. In some implementations of the invention, it may be desirable for efficiency reasons to bundle the multitude of individual requests into fewer requests that are then communicated to the postage vendor server 104.

In accordance with the illustrated embodiment of the invention, each request for postage sent by web server 102 includes the user's postage request and the user's payment mechanism (e.g., credit card information). The request is then sent to postage vendor server 104 for further processing.

In the Internet retailer model, a customer account database maintained by the retailer typically includes credit card information or the like. When a customer accesses the retailer site to obtain postage for a return, the retailer sends a postage request to the postage vendor server to obtain the necessary postage. Included in the postage request, is the customer's credit card information.

At step 309, web site 102 initiates a download of a postage printing software component 202 to the user's system. The download of the postage printing software component preferably, but not necessarily, occurs concurrently with sending postage requests to the postage vendor server for efficiency reasons. The postage printing software component provides a specialized printing capability and printer interface for handling the eventual printing of the postage to produce the indicium. This aspect of the invention is more fully described in U.S. patent application Ser. No. 09/708,185, entitled “System And Method Of Printing Labels,” filed on Nov. 7, 2000, which is incorporated herein by reference for all purposes. The postage printing software component can be a print DLL (dynamically linked library) software component that is dynamically installed into the OS, a Java® script that is downloaded and executed by the browser software, or other printing software implementations or techniques known to those of ordinary skill.

For each postage request, the postage vendor server verifies and debits the credit card account of the user requesting postage by an amount according to the requested postage (step 310). Alternatively, web site 102 or its operator submits payments for postage requests rather than the users. For example, the web site may have a corporate credit card which it uses for purchase of postage on behalf of its users, submitting the corporate credit card information with each user request. The web site is responsible for reconciling any account balance issues with its users. This embodiment illustrates an aspect of the invention which greatly increases the convenience of purchasing postage over the Internet. For example, an Internet retailer can provide a postage-guaranteed return policy to its customers as a convenience feature. Validation step 310 taken by postal vendor server 104 is substantially the same for either the user-provided or proxy-provided mechanism.

If validation is successful, postal vendor server 104 then generates information for printing an indicium for each stamp requested in the user postage request (step 312). In one embodiment, the indicium related information generated by the postal vendor server is in accordance with the IBIP specifications. For each indicium, the information for printing the indicium may include a bitmap of the indicium, a graphical image of the indicium, data representing the indicium, raw data corresponding to the indicium, or any other information which facilitates printing of the indicium. The information for printing the indicium is then communicated from the postal vendor server to web site 102 (step 314).

For example, the postage indicium data (raw data) typically contains the following information:

Postage Amount

Date

City of Origin

Postage Meter Number

Piece Serial Number

This information, which has not been fully processed, may be transmitted to proxy system 102 by the postal vendor server. Alternatively, the postal vendor server may transmit fully processed data, e.g., a bit map, that is ready for printing by printers with minimal intelligence. Thus, the “information for printing an indicium” or “first postage information” includes the full spectrum of data representations for the postage.

Optionally, when the web site receives the information for printing an indicium (first postage information), the information can be enhanced with an image provided by the web site to enhance the postage (step 316). Conventional postage stamps oftentimes are printed with a theme; for example, a flower series might consist of stamps in which the background is a print of a state flower. Likewise, the information for printing the indicium received by the web site can be enhanced with such images.

Numerous alternatives are possible for supplying the background image. The web site can provide its own pre-designed images and allow the user to select the desired image from them. Alternatively, the web site can be configured to allow for user-supplied images 208 (FIG. 2). In yet another embodiment, third party vendors can be used to provide background images.

Second postage information, e.g., the information for printing the indicium (optionally enhanced to contain a background image), is then sent to the user at user system 132 or 134 (step 318). The information received by the user is then used to print the indicium on a suitable medium. For example, a printer device 142 coupled to the user system may be used to print the indicium (or indicia). Postage printing software component 202 in the user system receives the information and interacts with the user system to print the postage (step 320). The postage printing software component automatically initiates an interactive print sequence upon receiving the information, prompting the user through the steps to print a postage indicium from the information received from the web site. As used herein, any information for printing indicium transmitted by the proxy system or web site to the user system is referred to as “second postage information.” Such information may be substantially identical to the first postage information or may be modified or enhanced version of the first postage information.

In one embodiment, a postage indicium may be printed on any suitable medium such as a label, paper, sheet of labels, envelopes, cards, directly on the mail piece/package, or other like media. One or more indicia may be printed at one time. Alternatively, the user may store the second postage information on a storage medium, such as a memory disk, for subsequent printing. This alternative embodiment enables a user having many parcels to accumulate all the needed postage before printing the postage.

In yet another embodiment, an off-line print program can be provided on user system 132 which allows the user to print out the postage at a later time. In this variation of the illustrative embodiment, the user's computer display includes a graphical icon of the off-line print program. The downloaded postage is displayed on the computer display as a series of document icons. In one version, the user employs a commonly used technique known as “drag-and-drop” to initiate off-line print program to print the postage. In this technique, one or more of the document icons representing the previously downloaded postage is (are) selected by the user and dragged over to the icon representing the off-line print program. In another version, the user simply double-clicks the print icon to initiate the off-line print program.

When the off-line print program is initiated, it establishes a communication link to the Internet to obtain the postage printing software component 202. This component may reside on proxy system 102, on the postage vendor server 104, or at some other convenient location on the Internet, or on a local network server. Alternatively, the postage printing software component can be hardcoded into to the off-line print program, or may be already installed in the Windows OS as a print DLL. Preferably, the postage printing program is obtained from a location on the Internet and downloaded on a per-use basis. This allows for the postage printing program to be easily maintained and updated to provide new printing features, enhanced user interfaces, and so on.

In an Internet retailer operation, the initiation of downloading and subsequent printing of postage can be accomplished using a “one-click” technique. The customer desiring to return goods purchased from the retailer simply inputs a number identifying the goods on the retailer's web page. A button is presented to the user, who then simply clicks on it to obtain the needed postage.

As can be gathered from the foregoing discussion, many printing alternatives are available, involving various user interaction paradigms, e.g., automatic printing, drag-and-drop printing, one-click, and so on. It is understood that these and other interaction methods can be easily incorporated into the present invention within the scope of the claims which set forth the invention.

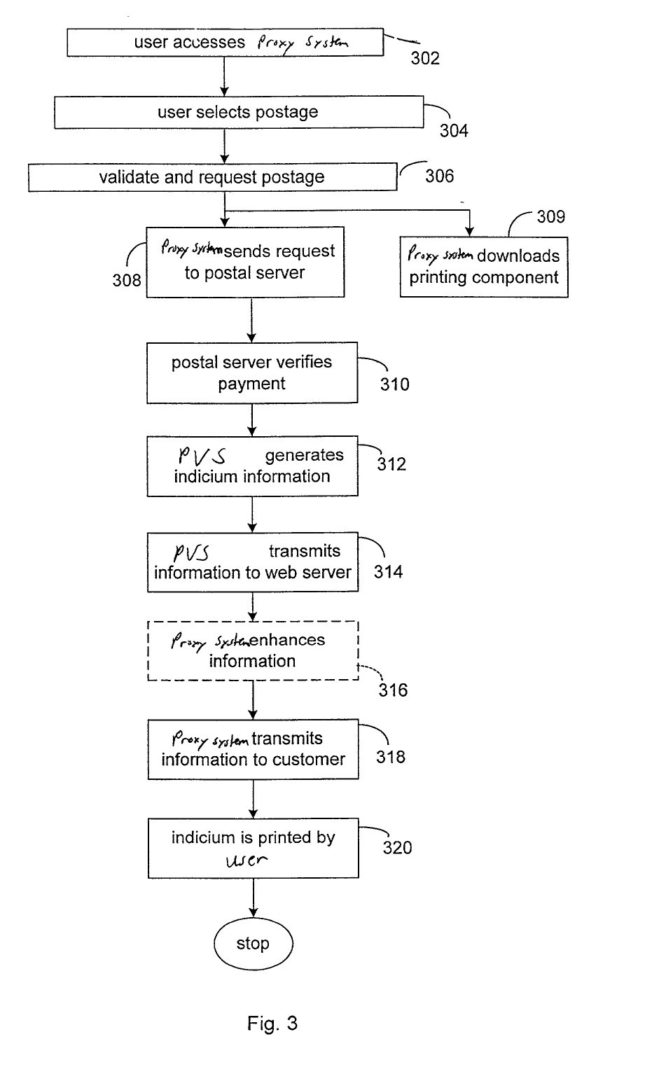

As stated above, the indicium may be printed on a label, paper, or other like medium, or even on the mail piece/package itself. FIG. 4 depicts an exemplary individual pre-printed label 400 on which the indicium may be printed according to an embodiment of the present invention. As shown in FIG. 4, label 400 has serrated edges 402 which not only serve as a security mechanism but also provide a look-and-feel of a conventional U.S. postage stamp. Other security features imprinted on label 400 may include a colored stripe 404, lines of micro-print 406, a label serial number 408, a logo 410, and a watermark 412. These security features may be placed at different locations on label 400. Many other configurations of label 400 are possible in other embodiments.

The security features shown in FIG. 4 are meant to reduce fraudulent copying or misuse of the label with the indicium printed on it. For example, colored stripe 404 may be in a color, for example, fluorescent pink, which cannot be easily copied by black and white copiers. Micro-print 406 may include the name of the postage vendor printed in an intricate manner. For example, micro-print 406 may contain the name “Neopost” printed repetitively. Further details related to the use of security features are discussed in U.S. application Ser. No. 09/611,375, entitled “Providing Stamps On Secure Paper Using A Communications Network,” filed Jul. 7, 2000, which is incorporated herein by reference for all purposes.

In one embodiment, a logo 410 is an image of a logo of the postage vendor. Alternatively, logo 410 may be selected or customized by the user purchasing the postage, e.g., during steps 316 and 318 of FIG. 3.

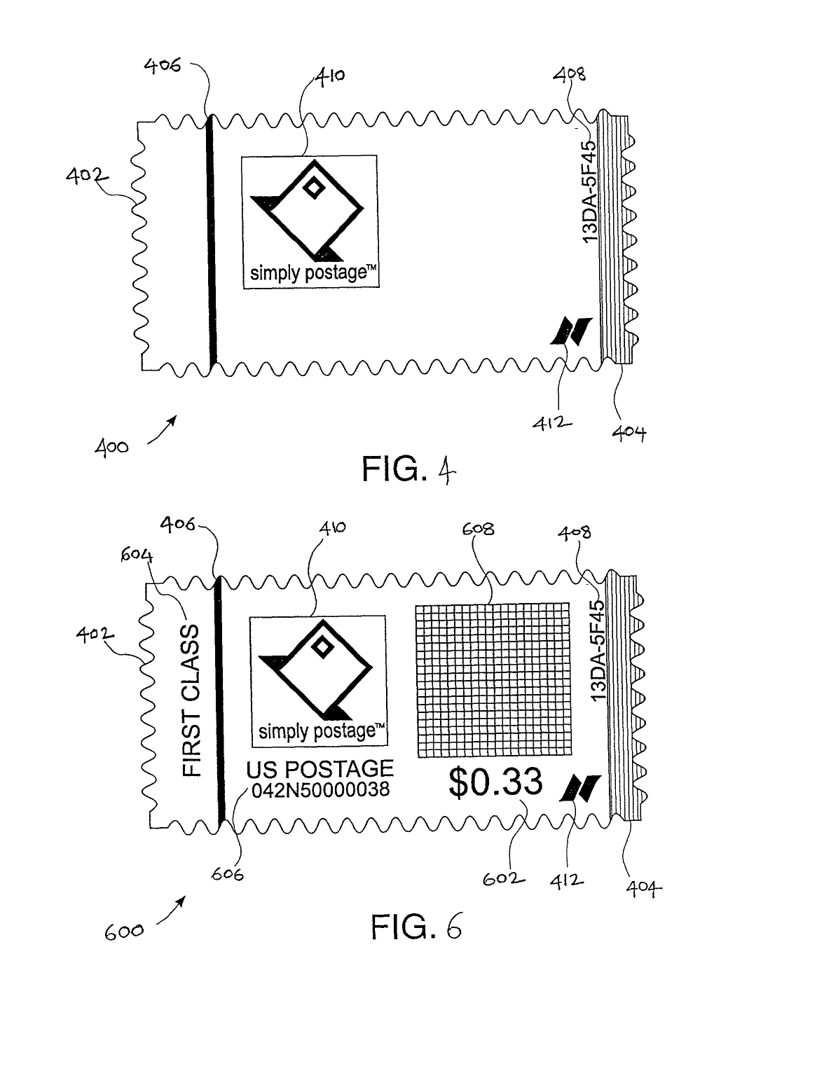

FIG. 5 depicts a sheet 500 of pre-printed labels according to an embodiment of the present invention. As shown in FIG. 5, sheet 500 comprises ten individual pre-printed labels depicted in FIG. 4. The number of individual labels on a sheet may vary in alternative embodiments of the present invention. Individual sheets may be serialized for increased security and a unique serial number corresponding to each sheet may be printed on the sheet, e.g. sheet serial number 502.

As part of configuring the user postage request, the user may be required to enter the unique serial number of the sheet on which the indicium is to be printed. The postage vendor system 104 may maintain a list of all available and valid sheet serial numbers and the number of unused labels corresponding to the sheets. After all the labels on a particular sheet have been used, the unique sheet serial number corresponding to the particular sheet may be invalidated by the postage vendor system. In this manner, misuse or fraud can be detected if the sheet serial number received from the user refers to an invalidated sheet serial number.

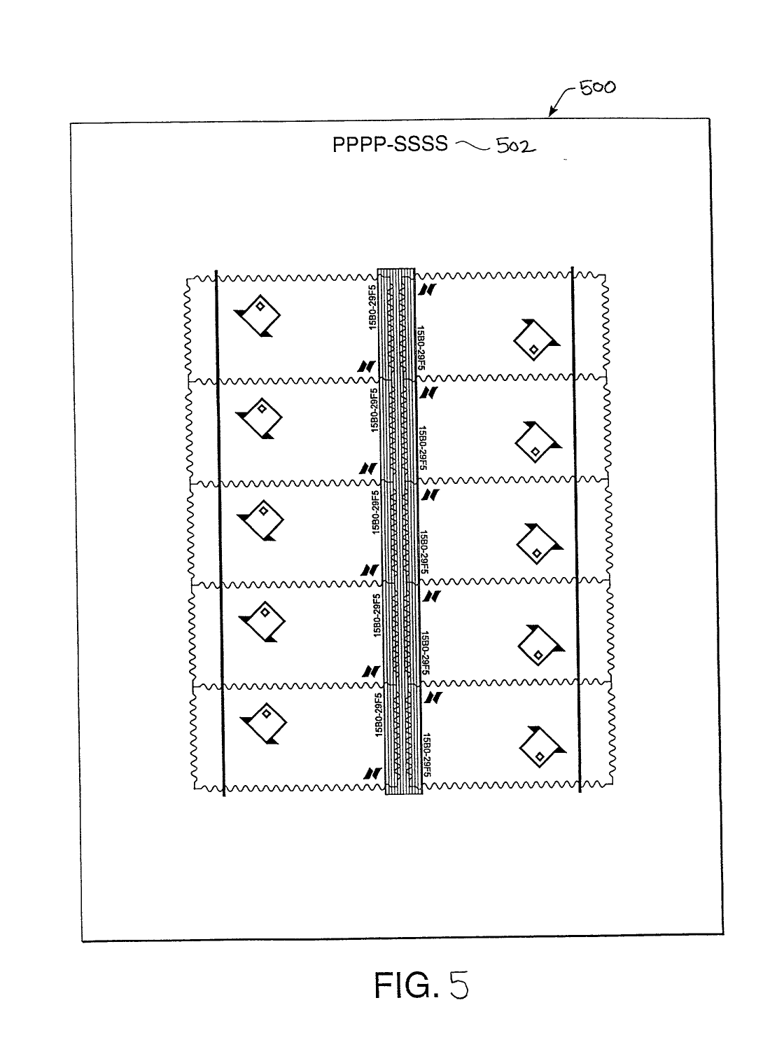

FIG. 6 depicts an individual label 600 with an indicium printed on it according to an embodiment of the present invention. In addition to features of a blank label (described above with respect to FIG. 4), label 600 has an indicium printed on it which may include human readable information and machine readable information. For example, the human readable information of the indicium may include the postage amount or value 602 (e.g. $0.33), the mail class 604 of the postage (e.g. FIRST CLASS), and number 606 (e.g., 042N5DD00038) corresponding to a Postal Security Device (PSD) resource from the pool of PSD resources on the postage vendor system which was used to generated the information for printing the indicium, as will be described in more detail below.

The machine readable portion of the indicium may include a two-dimensional code 608, which may be for example a PDF-417 barcode format, a DataMatrix format, or other format. According to an embodiment of the present invention, two-dimensional code 608 is DataMatrix. According to an embodiment of the present invention, the indicium and the positioning of the indicium on label 600 conform generally to specifications described in the IBIP specifications.

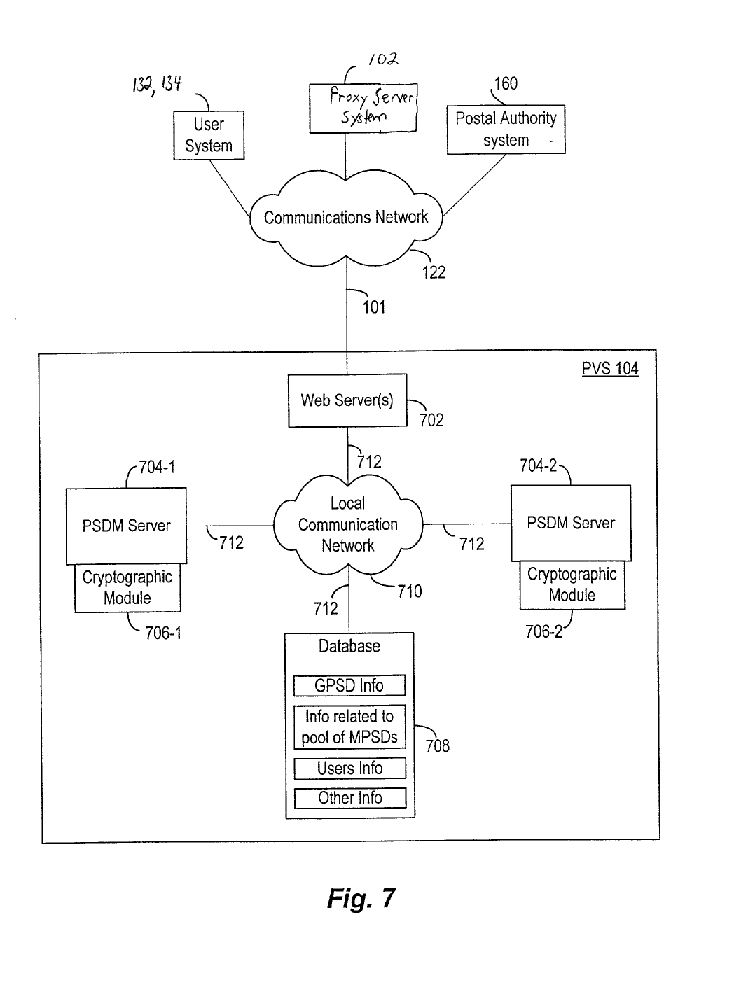

FIG. 7 depicts an expanded block diagram of postage vendor system (PVS) 104 coupled to user system 132 or 134, proxy system 102, and PAS 160 according to an embodiment of the present invention. As explained previously, the PVS 104 may process postage purchase requests from any one of these three types of systems: requests received directly from the user system, indirectly from the proxy system, or indirectly from the PAS that is functioning as a proxy system. As before, for purposes of illustration, the PVS 104 is described below using an embodiment of the present invention where users submit their requests to PVS 104 via proxy system 102.

As shown in FIG. 7, PVS 104 may comprise one or more web servers 702, one or more postal security device module (PSDM) servers 704 (with associated cryptographic modules 706), and a database 708 coupled to a local communication network 710 via a plurality of communication links 712. Local communication network 710 provides a mechanism for allowing the various components of postage vendor system 104 to communicate and exchange information with each other. Local communication network 710 may itself be comprised of many interconnected computer systems and communication links. Communication links 712 may be hardwire links, optical links, satellite or other wireless communications links, wave propagation links, or any other mechanisms for communication of information. The configuration of PVS 104 depicted in FIG. 7 is merely illustrative of an embodiment incorporating the present invention and does not limit the scope of the invention as recited in the claims. One of ordinary skill in the art would recognize other variations, modifications, and alternatives.

Web server 702 may host the postage vendor's web site and store web pages provided by the postage vendor. Web server 702 is responsible for receiving requests (“proxy requests”) from proxy system 102. When proxy system 102 requests communication with PVS 104, web server 702 may be configured to establish a communication link between proxy system 102 and PVS 104. For example, web server 702 may establish a secure Internet socket link. e.g. a SSL 2.0 link, between PVS 104 and proxy system 102. As noted above, the information communicated between the proxy system and the postal vendor system may be SSL encrypted using various encryption levels, e.g., 40-bit encryption, 128-bit encryption, and the like. Web server 702 may also incorporate a firewall which shields the internal postage vendor system network from communications network 122 and proxy system 102 and other resources coupled to communications network 122. In one embodiment, the web server is responsible for receiving requests to purchase postage and performing load distribution and fail-over processing associated with the requests.

Each PSDM server 704, in conjunction with one or more cryptographic modules 706 coupled to the PSDM server, is responsible for generating the information for printing the indicium (first postage information) in response to proxy requests. According to an embodiment of the present invention, functions performed by PSDM server 704 include functions performed by a Postal Security Device (PSD) as described in the IBIP specifications published by the USPS. For example, functions performed by PSDM server 704 include initialization and creation of PSD resources, digital signature generation, management of funds related to the postage dispensed by postage vendor system 104, generation of information for printing the indicia, key handling, and other functions. PSDM servers 704 are designed to operate in a clustered environment to allow for expandability to meet the needs of a rapidly growing user base. According to an embodiment of the present invention, PSDM server 704 communicates with web server 702 using a DCOM (Microsoft's Distributed Component Object Model) interface.

Each PSDM server 704 may comprise one or more cryptographic modules 706 for performing cryptographic functions and for generating digital signatures. Various keys for performing security-critical functions such as digital signature generation, hashing, encryption, etc. are stored by cryptographic module 706. According to an embodiment of the present invention, cryptographic module 706 is a nCipher nFast/CA module which is validated to FIPS 140-1 Level 3 security.

In one embodiment, PSDM server 704 uses PSD resources to generate indicia and to track monetary amounts related to the postage dispensed by postage vendor system 104. In order to increase the indicia generation throughput, a plurality of shared PSD resources may be used by PSDM servers 704 to generate the indicia. By using a plurality of PSD resources, multiple PSDM servers 704 can run concurrently, producing indicia in parallel without the bottleneck of sharing a single PSD resource.

Each PSD resource generally comprises a unique PSD identifier (e.g. a 4-byte identifier), a descending register (DR) value (e.g., a 4-byte value), an ascending register (AR) value (e.g., a 5-byte value), and a control code (e.g., a 20-byte value). The PSD identifier uniquely identifies each PSD resource. The ascending register (AR) value represents the total monetary value of all indicia ever produced by the PSD during its life cycle. The descending register (DR) value indicates the available funds assigned to the PSD resource which may be used to dispense postage. The monetary values stored by the AR and DR values are measured in 1/10 of 1-cent increments as specified in the IBIP specifications. The control code is a secure hash of the PSD identifier, the PSD AR value, and the PSD DR value. In one embodiment, the control code is generated using HMAC-with-SHA1 (RFC 2104) using a secret HMAC key stored by cryptographic module 706.

In one embodiment, monetary amounts related to the postage dispensed by postage vendor system 104 are tracked using a global PSD (GPSD) resource and a pool of PSD resources referred to as mini-PSDs (or MPSDs). Eight MPSD resources are generally used by a single cryptographic module 706 associated with PSDM server 704 to concurrently generate information for printing indicia. The sum of the AR value and the DR value of the GPSD represents the total amount of postage bought from the postal authority, for example, from the USPS, by the postage vendor or operator (e.g., Neopost) of postage vendor system 104. The sum totals of the AR and DR values of the MPSD resources matches the AR and DR values of the GPSD resource. Information related to the GPSD resource and MPSD resources may be stored in database 708.

According to an embodiment of the present invention, each MPSD resource may be assigned a unique number by the postage vendor. A number assigned to a particular MPSD may be included in the information for printing an indicium generated by the particular MPSD and printed as part of the indicium. For example, the number “042N50000051” (numeral 606 in FIG. 6) uniquely identifies the MPSD resource which was used for generating the information for printing the indicium depicted in FIG. 6. This MPSD serial number is like a meter number and may be used to track the MPSD resource responsible for generating information for printing the indicium.

Database 708 acts as a repository for storing information related to the postage dispensing process. For example, database 708 may store information related to the PSD resources (both GPSD and MPSDs), information used for generation of digital signatures, and other like information. Database 708 may also store the postal license number assigned to postage vendor system 104 by the postal authority. Other information related to the dispensing of postage may also be stored by database 708. The term “database” as used in this application may refer to a single database or to a plurality of databases coupled to local communication network 710. Further, database 708 may be a relational database, an object-oriented database, a flat file, or any other way of storing information. According to an embodiment, database 708 is coupled to web server 702 and to PSDM server 704 via an ODBC interface.

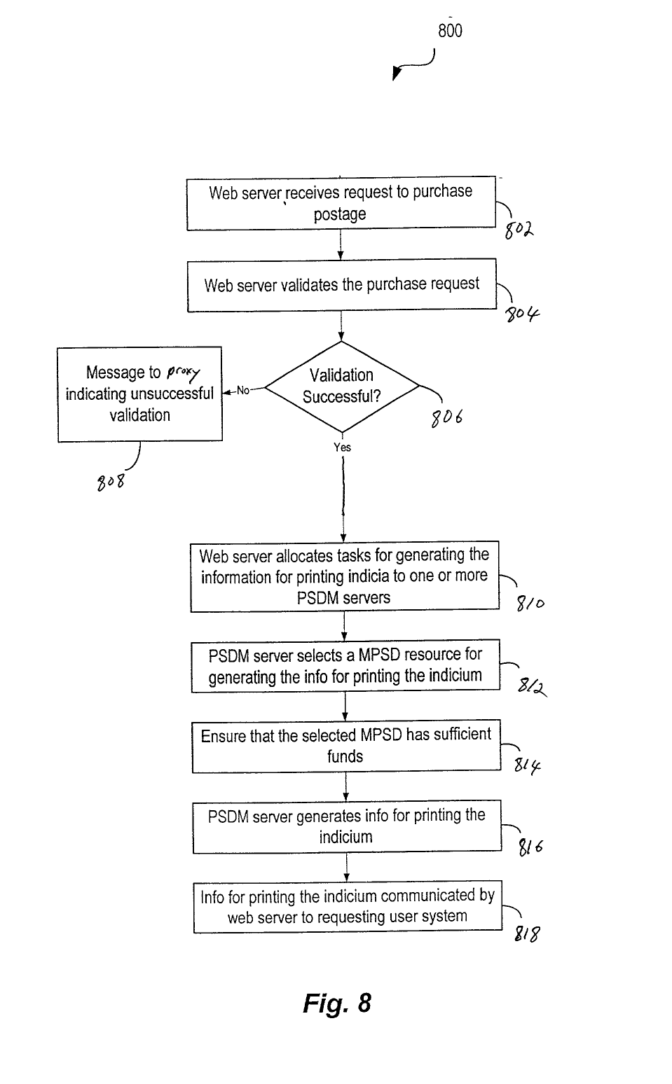

FIG. 8 is a simplified flowchart 800 showing processing performed by the various components of postage vendor system 104 upon receiving a request to purchase postage according to an embodiment of the present invention. Web server 702 receives a request from proxy system 102 to purchase postage (step 802). In one embodiment, the proxy request may be transmitted to postage vendor system 104 in the form of a data structure in Extensible Markup Language (XML). Web server 702 may then validate the purchase request received from proxy system 102 (step 804). As part of the validation step, web server 702 may check the validity of the user, the validity of credit-card information, the validity of proxy system 102 and its corporate account with the postal vendor, the validity of information identifying the medium on which the indicia are to be printed, e.g. sheet serial numbers and/or label serial numbers provided by the user, and/or validity of other information related to the purchase request. Various other validation checks may also be performed according to alternative embodiments of the present invention.

Checking credit card validity may involve checking if the user has provided a valid credit card number, ensuring that the user name on the credit card is valid, ensuring that the credit card has not expired, and getting authorization from the credit card company for the value of the postage and other expenses if any, and other checks. Services provided by companies such as Cybercash and Cybersource may be used to perform the validation. If the user is a registered user with a pre-funded account, web server 702 may determine if the user has sufficient funds in the user's account to pay for the postage to be purchased.

Web server 702 then checks whether any of the validation checks performed in step 804 failed (step 806). If any validation check failed, web server 702 may send a message back to proxy system 102 indicating that the validation was unsuccessful (step 808). The message communicated to proxy system 102 may provide reasons for the failure. The user may then be provided with a chance to remedy the reason for the validation failure.

If it is determined in step 808 that the validation checks performed in step 804 were successful, web server 702 then, based on the purchase request, determines the number of stamps for which information for printing the indicium have to be generated and the tasks for generating the information are allocated to one or more PSDM servers 704 (step 810). In this manner, web server 702 distributes the indicium related information generation work load among PSDM servers 704 coupled to local communication network 710. Web server 702 may use different allocation schemes/algorithms to distribute the work among PSDM servers 704.

According to an embodiment of the present invention, web server 702 maintains a list of all PSDM servers 704 coupled to local communication network 710. For example, a list of available PSDM servers 704 may be stored in the Windows NT registry of web server 702. A system administrator may add or remove PSDM servers using a Windows NT registry editor. According to another embodiment, a proxy software (e.g. C++) class may be provided which stores a list of the available PSDM servers 704. Information related to PSDM servers 704 may also be stored in database 708. Web server 702 may then use an allocation scheme such as a round-robin scheme to distribute the work. For example, if there are two PSDM servers available, web server 702 will alternate sending indicium printing information generation requests to the two PSDM servers. According to this embodiment, if the proxy system has requested the purchase of two US $0.33 stamps, the task of generating information for printing the indicium for the first US PSDM server. In this manner, web server 702 makes optimal use of available PSDM servers 704. It should be apparent that various other allocations schemes/algorithms may also be used by web server 702.

Once the task to generate information for printing an indicium for a stamp has been assigned to a PSDM server 704, the PSDM server selects an MPSD resource to be used for generating the information for printing the indicium (step 812). In one embodiment, when PSDM server 704 is initialized, for example during system startup, PSDM server 704 acquires exclusive rights to one or more MPSD resources stored in database 708 which will be used to service requests for indicia generation. In essence, PSDM server 704 “checks out” one or more MPSD resources from database 708. PSDM server 704 then goes online and waits for requests to generate information for printing indicia. When PSDM server 704 receives a request to generate information for printing an indicium from web server 702, PSDM server 704 selects one of the previously checked out MPSD resources for generating the information.

PSDM server 704 ensures that the selected MPSD resource has sufficient funds to satisfy the postage request (step 814). If the selected MPSD resource does not have sufficient funds to satisfy the postage request, then PSDM server 704 may perform processing to fund the selected MPSD resource.

PSDM server 704 then generates the information for printing the requested indicium using the selected (and sufficiently funded) MPSD (step 816). PSDM server 704 adjusts the AR and DR values of the selected MPSD resource corresponding to the value of the requested stamp for which indicium is to be generated. The AR value of the selected MPSD resource is increased by the amount of the stamp while the DR value of the selected MPSD resource is decreased by the stamp value. The AR and DR values for the MPSDs along with other information related to the MPSDs may be stored in database 708.

The information for printing the indicium generated in step 816 is then forwarded by PSDM server 704 to web server 702 which communicates the information to requesting proxy system 102 as the first postage information (step 818). The first postage information downloaded to requesting proxy system 102 may include various types of information representing the indicium (or indicia). The first postage information received by the proxy system may transmitted to user system 132 in substantially the same condition or in a modified or enhanced condition, as explained previously in connection with FIG. 3.

Although specific embodiments of the invention have been described, various modifications, alterations, alternative constructions, and equivalents are also encompassed within the scope of the invention. The described embodiments of the invention are not restricted to operation within certain specific data processing environments, but are free to operate within a plurality of data processing environments. Additionally, although the embodiments of the present invention have been described using a particular series of transactions and steps, it should be apparent to those skilled in the art that the scope of the present invention is not limited to the described series of transactions and steps.

Further, while the embodiments of the present invention has been described using a particular combination of hardware and software, it should be recognized that other combinations of hardware and software are also within the scope of the present invention. The embodiments of the present invention may be implemented only in hardware or only in software or using combinations thereof.

The specification and drawings are, accordingly, to be regarded in an illustrative rather than a restrictive sense. It will, however, be evident that additions, subtractions, substitutions, and other modifications may be made without departing from the broader spirit and scope of the invention as set forth in the claims.

What is claimed is:

1. A method for dispensing postage, comprising:
receiving, at a first server system, a first request from a user system to purchase postage, the first request including one or more characteristics of postage desired by a user;
transmitting a second request to a second server system in response to the first request, the second server system being authorized to dispense postage from a postal authority;
sending first information for printing a postage indicium from the second server system to the first server system; and
transmitting second information for printing the postage indicium from the first server system to the user system.

2. The method of claim 1, wherein the first server system is a postal authority system.

3. The method of claim 1, wherein the first server system is a system operated by the United States Postal Service.

4. The method of claim 1, wherein the first information is different from the second information, the second information includes the first information and information on a background image of the postage indicium.

5. The method of claim 1, further comprising:
printing the postage indicium on a printable medium at the user system using the second information.

6. The method of claim 1 further comprising:
selecting a background image to be combined with the first information to generate the second information.

7. The method of claim 1, further comprising:
receiving information about a product purchased from a retailer affiliated with the first server system from the user system;
identifying the product at the first server system;
estimating cost of shipping the product from a user location to a retailer location, wherein the second request is transmitted from the first server system to the second server system with information representing the estimated shipping cost; and
shipping the product with the printed postage indicium affixed thereto from the user location to the retailer location.

8. The method of claim 7, wherein the retailer or its affiliate has an account established with the postal authority to settle any postage deficiency in connection with shipping the product to the retailer location or to receive credit for any postage overcharge in connection with shipping the product to the retailer location.

9. The method of claim 8, wherein the postage deficiency is the difference between an actual postage cost of shipping the product and a value of the printed postage indicium if the difference is a positive value, and the postage overcharge is the difference between an actual postage cost of shipping the product and a value of the printed postage indicium if the difference is a negative value.

10. The method of claim 8, wherein the retailer or its affiliate bills or credits the user for the postage deficiency or overcharge.

11. The method of claim 7, wherein the postal authority is a governmental agency, quasi-governmental agency, or private entity.

12. The method of claim 1, wherein the first server system is a proxy server system and the second server system is a postal vendor system.

13. The method of claim 1, wherein the first server system is not authorized to dispense postage by the postal authority.

14. A method for dispensing postage, comprising:
receiving, at a postal vendor system, a proxy request from a proxy server system, the proxy server system generating the proxy request in response to a postage purchase request including one or more criteria about desired postage from a user; and
transmitting first postage information for printing a postage indicium that satisfies the one or more criteria from the postal vendor system to the proxy server system,
wherein the proxy system is not authorized to dispense postage and the postal vendor system is authorized to dispense postage by a postal authority.

15. The method of claim 14, further comprising:
accessing the proxy server system by the user to make the postage purchase request; and
selecting desired postage to generate the purchase request.

16. The method of claim 15, further comprising:
transmitting second postage information for printing the postage indicium that satisfies the one or more criteria from the proxy server to the user.

17. The method of claim 16, further comprising;
printing the postage indicium on a suitable medium using the second postage information from the proxy server.

18. The method of claim 16, further comprising:
storing the second postage information at a user system for subsequent printing of the postage indicium.

19. The method of claim 16, wherein the second postage information is fully processed data that is ready for printing at a user system.

20. The method of claim 16 wherein the second postage information includes one or more bitmap images.

21. The method of claim 14, further comprising:
receiving information about a product purchased from a retailer affiliated with the proxy system from the user;
identifying the product using the information about the product purchased;
determining cost of shipping the product from a user location to a retailer location, wherein the proxy request incorporates information representing the determined shipping cost;
printing the postage indicium using the second postage information; and
shipping the product with the printed postage indicium affixed thereto from the user location to the retailer location.

22. The method of claim 21, wherein the retailer or its affiliate has an account established with the postal authority to settle any postage deficiency in connection with shipping the product to the retailer location or receive credit for any postage overcharge in connection with shipping the product to the retailer location.

23. The method of claim 22, wherein the postage deficiency is the difference between an actual postage cost of shipping the product and a value of the printed postage indicium if the difference is a positive value, and the postage overcharge is the difference between an actual postage cost of shipping the product and a value of the printed postage indicium if the difference is a negative value.

24. The method of claim 23, wherein the retailer or its affiliate bills or credits the user for the deficiency or overcharge.

25. The method of claim 21, wherein the postal authority is a governmental agency, quasi-governmental agency, or private entity.

26. A communication system for dispensing postage, comprising:
a communication network;
a proxy server system coupled to the communication network and configured to receive a postal purchase request that includes one or more criteria about desired postage from a user and generate a proxy request in response to the postal purchase request, wherein the proxy system is not authorized to dispense postage by a postal authority; and
a postal vendor system coupled to the communication network and configured to receive the proxy request from the proxy server system and generate first postal information for printing a postage indicium in response to the proxy request, wherein the postal vendor system is authorized to dispense postage by the postal authority.

27. The system of claim 26, wherein the proxy server is configured to transmit second postage information for printing the postage indicium to the user.

28. The system of claim 27, further comprising:
a user system that is configured to print the postage indicium on a suitable medium using the second postage information from the proxy server.

29. The system of claim 27, further comprising:
a user system that is configured to store the second postage information at the user system for subsequent printing of the postage indicium.

30. A computer program product for dispensing postage stored on a computer-readable medium, comprising:
code for a proxy server system to generate a proxy request in response to a postage purchase request including one or more criteria about desired postage from a user
code for receiving, at a postal vendor system, the proxy request from the proxy server system; and
code for transmitting first postage information for printing a postage indicium from the postal vendor system to the proxy server system,
wherein the proxy system is not authorized to dispense postage and the postal vendor system is authorized to dispense postage by a postal authority.

31. The computer program product of claim 30, further comprising:
code for allowing the user to select desired postage to generate the purchase request

32. The computer program product of claim 31, further comprising:
code for transmitting second postage information for printing the postage indicium from the proxy server to the user.

33. The computer program product of claim 32, further comprising;
code for printing the postage indicium on a suitable medium using the second postage information from the proxy server.

34. The computer program product of claim 32, further comprising:
code for storing the second postage information at a user system for subsequent printing of the postage indicium.

35. The computer program product of claim 30, further comprising:
code for receiving information about a product purchased from a retailer affiliated with the proxy system from the user;
code for identifying the product using the information about the product purchased;
code for determining cost of shipping the product from a user location to a retailer location
code for transmitting the proxy request from the proxy system to the postal vendor system with information representing the determined shipping cost; and
code for printing the postage indicium using the second postage information.

36. The computer program product of claim 35, further comprising:
code for billing or crediting the user for any postal deficiency or overcharge.

37. A method for dispensing postage, comprising:
receiving, at a postal vendor system, a proxy request from a postal authority system, wherein the proxy request is generated by the postal authority system in response to a postage purchase request received from a user, the postage purchase request including one or more criteria about postage desired by the user.

38. The method of claim 38, further comprising:
transmitting first postage information for printing a postage indicium that satisfies the one or more criteria from the postal vendor system to the postal authority system.

39. The method of claim 37, wherein the postal vendor system is authorized to dispense postage by a postal authority operating the postal authority system.

40. The method of claim 37, wherein the postal authority system is a system operated by the United States Postal Service.

41. The method of claim 37, wherein the postage purchase request is generated in response to the user accessing the postal authority system and selecting desired postage.

42. The method of claim 37, further comprising:
transmitting second postage information for printing the postage indicium that satisfies the one or more criteria from the postal authority to the user.

43. The method of claim 42, further comprising;
printing the postage indicium on a suitable medium using the second postage information from the postal authority system.

44. The method of claim 42, further comprising:
storing the second postage information at an information storage medium for subsequent printing of the postage indicium.
